(19) United States
(12) Patent Application Publication
(10) Pub. No.: US 2025/0037027 A1
(43) Pub. Date: Jan. 30, 2025

(54) SYSTEMS AND METHODS FOR AUTOMATICALLY GENERATING HIGH-FIDELITY SURROGATES OF DYNAMICAL SYSTEMS

(71) Applicant: JuliaHub, Inc., Boston, MA (US)

(72) Inventors: Christopher Rackauckas, Cambridge, MA (US); Anas Abdelrehim, Toronto (CA)

(21) Appl. No.: 18/782,467

(22) Filed: Jul. 24, 2024

Related U.S. Application Data
(60) Provisional application No. 63/515,260, filed on Jul. 24, 2023.

(51) Int. Cl. G06N 20/00

(52) U.S. Cl. CPC G06N 20/00

(57) ABSTRACT

Systems and methods for generating a training dataset for training a surrogate are disclosed. The surrogate represents a physical system that receives input from the controller. The training dataset is generated without knowledge of how the controller works. A user configures a space from which to sample controllers, and multiple randomized controllers are generated from the configured space. The multiple randomized controllers are simulated, and the resulting dataset from the simulation is used to train the surrogate. The trained surrogate is validated against known data that is not part of the training dataset. Additional controllers are sampled and further data is generated for training of the surrogate.

### CROSS-REFERENCE TO RELATED APPLICATIONS

This application claims priority to U.S. Provisional Patent Application No. 63/515,260 (Attorney Docket No. 1207/15 PROV), filed on Jul. 24, 2023, entitled “SYSTEMS AND METHODS FOR AUTOMATICALLY GENERATING HIGH-FIDELITY SURROGATES OF DYNAMICAL SYSTEMS,” the entire contents of which is incorporated by reference herein.

### TECHNICAL FIELD

The field of the invention relates generally to scientific computing. Specifically, the field of invention relates to systems and methods for training and validating a surrogate model of a dynamical system using training data that is generated by the systems and methods based on input received from a user.

### BACKGROUND

Many simulations of real-world phenomena, from physical and biological to chemical processes, are described by systems of differential equations, such as ordinary differential equations (ODEs) and differential-algebraic equations (DAEs). In many cases, these equations are computationally expensive to solve. To improve the numerical performance of the simulation process, a surrogate (also known as a metamodel) may be used. A surrogate is a data-driven model designed to approximate the original model. However, the results provided by the surrogate depend, in large part, on how well the surrogate has been trained. Existing methods of generating and/or training surrogates for large-scale models are prohibitively expensive in terms of computational resources and training time.

Accordingly, it would be desirable to have systems and methods for training surrogates for large-scale models that generate accurate surrogates without using significant computational resources to train the surrogate. In particular, it would be desirable to have systems and methods that generate data such that when the surrogate is trained using that generated data, the surrogate can handle the real-world controller, even when the parameters of the real-world controller are unknown.

### BRIEF DESCRIPTION OF THE DRAWINGS

The present embodiments are illustrated by way of example and are not intended to be limited by the figures of the accompanying drawings.

FIG. 1 depicts a comparison of a real-world physical system versus a digital simulation versus a surrogatized system.

FIG. 2 depicts a block diagram showing data flow for generating a training dataset used to train and validate the surrogate.

FIG. 3 depicts examples of sampled controllers 206 shown in FIG. 2.

FIG. 4 depicts an exemplary process flow for training a surrogate model representing a physical system without knowledge of a controller for the physical system.

FIG. 5 depicts an exemplary GUI to allow the user to tune or define one or more controllers.

FIG. 6 depicts a block diagram illustrating one embodiment of a computing device that implements the methods and systems described herein.

FIG. 7 depicts a graph showing the states phase space.

FIG. 8 depicts results showing an inference hold-out validation sample.

FIG. 9 depicts results showing the inference on the training sample.

### SUMMARY

The features and advantages described in this summary and the following detailed description are not all-inclusive. Many additional features and advantages will be apparent to one of ordinary skill in the art in view of the drawings, specification, and claims presented herein.

Systems and methods for generating a training dataset for training a surrogate are disclosed. The surrogate represents a physical system that receives input from the controller. The training dataset is generated without knowledge of how the controller works. A user configures a space from which to sample controllers, and multiple randomized controllers are generated from the configured space. The multiple randomized controllers are simulated, and the resulting dataset from the simulation is used to train the surrogate. The trained surrogate is validated against known data that is not part of the training dataset. Additional controllers are sampled and further data is generated for training of the surrogate.

In an embodiment, a system for training a surrogate model representing a physical system without knowledge of a controller for the physical system is disclosed. The system includes one or more hardware processors. The one or more hardware processors are configured for configuring space from which to sample one or more controllers to generate a configured space of controllers. The space is configured based on input received from a user. The input received from the user may be provided through a graphical user interface (GUI). The GUI may allow the user to configure one or more parameters. The GUI may include a graph representing a controller and the one or more parameters may be configured visually. In various embodiments, the input received from the user may include a lower-bound controller and an upper-bound controller (i.e. controllers which exhibit extreme behaviors in terms of parameterizations). The space may be configured programmatically or algorithmically based on the input received from the user. The one or more hardware processors are further configured for sampling a first plurality of controllers from the configured space to generate a set of sampled controllers. Each controller of the first plurality of controllers may be a randomized controller. The set of sampled controllers captures locally diverse dynamics of the physical system. The set of sampled controllers may be proportional-integral-derivative controllers, dynamical system controllers, feed-forward architecture controllers, and/or surrogate controllers. The one or more hardware processors are further configured for simulating each of the plurality of controllers using a simulation to generate a dataset from the simulation. The simulation may be an open-loop simulation or a closed-loop simulation. The one or more hardware processors are further configured for training a surrogate using the dataset from the simulation. The one or more hardware processors are further configured for validating the trained surrogate using data from the physical system. The data from the physical system used to validate the trained surrogate is not part of the dataset from the simulation used to train the surrogate. The one or more hardware processors are further configured for sampling a second plurality of controllers based on the validation of the trained surrogate to further train the surrogate.

In another embodiment, a programmatic method for training a surrogate model representing a physical system without knowledge of a controller for the physical system is disclosed. The programmatic method includes configuring space from which to sample one or more controllers to generate a configured space of controllers. The space is configured based on input received from a user. The input received from the user may be provided through a graphical user interface (GUI). The GUI may allow the user to configure one or more parameters. The GUI may include a graph representing a controller and the one or more parameters may be configured visually. In various embodiments, the input received from the user may include a lower-bound controller and an upper-bound controller (i.e. controllers which exhibit extreme behaviors in terms of parameterizations). The space may be configured programmatically or algorithmically based on the input received from the user. The programmatic method further includes sampling a first plurality of controllers from the configured space to generate a set of sampled controllers. Each controller of the first plurality of controllers may be a randomized controller. The set of sampled controllers captures locally diverse dynamics of the physical system. The set of sampled controllers may be proportional-integral-derivative controllers, dynamical system controllers, feed-forward architecture controllers, and/or surrogate controllers. The programmatic method further includes simulating each of the plurality of controllers using a simulation to generate a dataset from the simulation. The simulation may be an open-loop simulation or a closed-loop simulation. The programmatic method further includes training a surrogate using the dataset from the simulation. The programmatic method further includes validating the trained surrogate using data from the physical system. The data from the physical system used to validate the trained surrogate is not part of the dataset from the simulation used to train the surrogate. The programmatic method further includes sampling a second plurality of controllers based on the validation of the trained surrogate to further train the surrogate.

### DETAILED DESCRIPTION

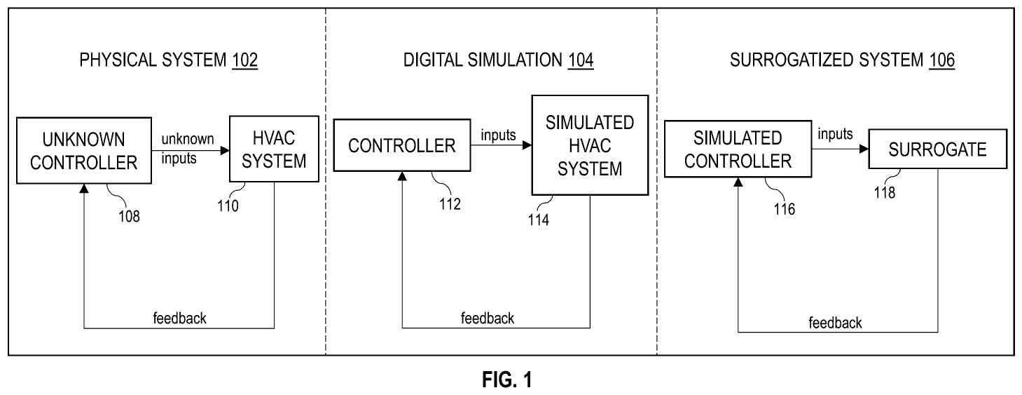

FIG. 1 depicts a comparison of a real-world physical system versus a digital simulation versus a surrogatized system. The example shown in FIG. 1 refers to an HVAC system, although it will be understood that the concepts described herein may be applied equally to other types of systems. Referring to FIG. 1, there is shown a physical system 102, a digital simulation 104, and a surrogatized system 106. The physical system 102 represents a real-world system, for example, an HVAC system 110. The HVAC system 110 may be controlled by a controller 108, which provides inputs to the HVAC system 110. The details of the controller 108 itself may be unknown to outside observers, and it may provide unknown inputs to the HVAC system 110. The HVAC system 110 may further provide feedback to the controller 108, forming a closed-loop system. The digital simulation 104 represents a simulated HVAC system 114 (i.e., a computer simulation of the real-world HVAC system 110). Like the real-world HVAC system 110, the simulated HVAC system 114 likewise may receive inputs from the controller 112 and provide feedback to the controller 112 in a closed-loop manner. One issue with the simulated HVAC system 114 of the digital simulation 104 is that the simulation can be computationally expensive and/or inefficient at scale. Finally, FIG. 1 shows the surrogatized system 106, which includes a surrogate 118. The surrogate 118 is a model that simulates the real-world HVAC system 110 much more quickly and using fewer computational resources than the simulated HVAC system 114 of the digital simulation 104. The surrogate 118 receives inputs from the simulated controller 116 and provides feedback to the simulated controller 116. The systems and methods described herein generate a training dataset for training the surrogate 118, when the details of the controller 108 being simulated may be known or unknown, as in the physical system 102 shown in FIG. 1.

Consider an ordinary differential equation (ODE) u′=f(u,p,t), where u is the state of the differential equation, p are the parameters of the equation, and t is the independent variable. For this system, a surrogate F of the time-series model is a function that attempts to satisfy the relation F(p)(t)=u(p,t), namely F(p) returns a function g(t) which matches the solution u(t) for the given parameters p. With an accurate enough surrogate model F(p), which is trained over the physically relevant parameter space and which is faster to evaluate than the original simulation, analyses that require simulating with parameters p can be replaced with evaluations of the surrogate at p for improved performance. Many classical surrogate and reduced-order modeling methods, such as POD, DLRA, radial basis function surrogates, deep neural network surrogates, and gaussian process (kriging) methods focus on this.

In contrast to the traditional approach, which focuses on attempting to learn the solution to a system, the systems and methods described herein instead focus on attempting to learn the model of the system, or the dataset that represents how the model behaves. Put another way, the systems and methods described herein attempt to learn the surrogates of the dynamics. In other words, it is desirable to find C(u,p,t) such that solving u′=C(u,p,t) is cheaper and faster than solving u′=f(u,p,t) for a subset of observables (subset of u) or for the fully observed states. To differentiate the two versions of the surrogates, C is referred to as a component surrogate herein, and F is referred to as a full-model surrogate herein.

As a simplification-which is satisfied by the vast majority of physical models that are simulated—the system can be assumed to be autonomous. In other words, it can be assumed that f(u,p,t)=f(u,p), and therefore the derivatives of the system have no explicit time dependence. The reasoning behind this assumption is that blocks within an equation-based modeling system are only reusable if they do not have an explicit dependence on global time.

For example, consider the HVAC system 110 referred to in FIG. 1. The HVAC system 110 heats and cools depending on the current state of the physical system 102, such as the current temperature of the environment and the refrigerants. Explicit time dependencies in such a physical system may exist, for example, in the form of a controller that is tuned to turn the HVAC system on at 3 am. However, as part of standard reusable modeling practice in a component-based modeling system, the controller 108 and the HVAC system 110 are represented as separate components, with the complex physical HVAC model being time-independent and only the simple controller time-dependent, and the systems and methods described herein surrogatize (i.e., build a surrogate of) only the physical HVAC system 110, thus the autonomous system assumption holds.

It is also important to note that the HVAC system 110 itself comprises several components, such as the compressor, the refrigerant, pipes, and the like. These components themselves are governed by controllers whose action depends on the states of the other components in the HVAC system.

In the sense of a component-based modeling framework, it is desirable to understand the behavior of a component of the model, which can be represented as c(u,p,i), where i(t) (e.g., in an open-loop system) or i(u,p,t) (e.g., in a closed-loop system) is an input function to the component c. For the HVAC system 110, c(u,p,i) represents the dynamics of the internal states of the HVAC system 110, and i(t) represents the controller 108 for the HVAC system 110.

With the assumption that the system to surrogatize is autonomous, the underlying problem of generating an accurate surrogate reduces to finding the subset ũ of the state space u such that C(u,p,i) is approximately equal to c(u,p,i) over the whole of u. For the surrogate to be predictive, the set u must cover all of the areas of phase space that would be seen in a simulation with the object f. In theory, this can only be known by running the original model in all of the possible contexts the component may be used. For example, the internal state u of the HVAC system 110 would be values such as the current temperature of the refrigerant and the pressure of an internal pipe. To explore all potential values of u, the HVAC system would need to be run in a simulation that approximates both summer and winter weather. In addition, the system would need to be approximated with a strong controller that frequently uses the refrigerant, as well as with controller settings that are relatively weaker. In theory, the set of possible scenarios would be unbounded, and every value of u is possible, which would lead to impossibly large compute requirements when attempting to generate training data. In practice, however, only a small subset of values is likely, due to the physical properties of the system. For example, hotter temperatures increase the pressure a fluid exerts, and therefore temperature and pressure would be expected to be relatively correlated. In other words, the space of U where, for example, the refrigerant temperature is high and the pipe pressure is low is unlikely to be seen in any simulation setup. In addition, as a digital twin of a real system, such an object would be subject to physical bounds. For example, the pipes would have a maximum pressure for which the model is meaningful, and beyond which the pipes would burst. This suggests that for realistic scenarios, it is likely that there exists a small subset Ũ of the potential phase space U which is likely ever realized in simulations. Thus, to efficiently train the surrogate model C, this U needs to be sufficiently explored through the data generation.

To learn this over all p, i.e., all parameters of the system, this process would need to be repeated over the space of all possible parameters. The set of possible parameters are assumed to be known a priori and determined by the user of the software.

Generating Training Datasets Through Structured Exploration with Randomized Controllers

The systems and methods described herein determine a viable training dataset that is less than the full training dataset across all possible setups. To theoretically determine the viable set, a system would effectively need to be run in all possible setups. In the HVAC system example of FIG. 1 discussed herein, this would mean running the HVAC model from some starting points with all possible controller inputs i(t) or i(u,p,t). However, for realistic systems, most controller configurations are unseen in practice. Generating data for such systems can be wasteful and computationally expensive, requiring the operation of the entire HVAC model to observe the individual component's input and its corresponding response. For example, an HVAC controller that turns on a heat pump when the system is already hot would be unstable, as the heat pump operation would lead to more heat to run the heat pump more for more heat and so on. As such, the set u can be traversed by inputs which lead to stable systems, assuming the approximation accuracy will decrease in the unstable settings. Thus, discovering the set U can be done by choosing sufficiently good starting points and solving systems with stable controller inputs i(t) or i(u,p,t). The systems and methods described herein include multiple embodiments for choosing sufficiently good starting points and solving systems with the stable controller inputs.

For example, in one embodiment, to choose starting points, the systems and methods described herein receive or otherwise use (u,p) pairs that are provided by a user as representative runs of the component in practice. In one embodiment, if no such prior information exists, random choosing of points, using methods such as a low discrepancy sequence (Latin Hypercube, Sobol points, etc.) can be used to give points throughout the space under the assumption that the user has provided upper and lower bounds to the physically possible (u,p). Then new points for the training set Ũ can be generated by solving simulations starting from these points. In another embodiment, the starting points may be found algorithmically based on a set of constraints, for example, varying the initial condition of the control input, as well as the initial guess of the states may be used with these sampling methods to also identify valid, relevant starting points.

However, in order to simulate a component c(u,p,i), an input function i(t) must be chosen. To define this input function, in one embodiment, the systems and methods described herein may use randomized controllers with bounded behavior to ensure the resulting system is stable. This may be done, for example, by using random controllers that are tuned to force the system back to the set point that is the starting point of the simulation. In one embodiment, once this is done, all of the points from the previous trajectory may be added to the space of possible starting trajectories, and the procedure is continually repeated until an approximation for Ũ is found. By allowing large enough gains on the controller, the system will be less stable and explore the space more. Systems that are too unstable are rejected from the training dataset. Additional details of various embodiments of this process are provided below.

To assess whether ũ is sufficiently explored, a test against a hold-out dataset can be conducted. The hold-out dataset includes data that is not part of the training dataset. If given (u,p) points from the user which cover the sample subspace in the observable phase space (e.g., points that are representative) of real runs of the component in a connected system, then before starting the data generation procedure, the set of (u,p) points can be split so that part of the set is used as starting points, and the other part is kept as a hold-out dataset D. One metric for determining if the process has explored the space relatively well is whether for every point d in D, there is a point u in u that is sufficiently close. Thus, in one embodiment, as a diagnostic, the diagnostic distance is defined as the value of the distance for d which is furthest from any point in ũ. The data generation procedure runs until this distance is sufficiently small. Other metrics for determining whether the space has been sufficiently explored may also be used.

Once this is achieved, the dataset u is assumed to be representative of the (u,p) points that would likely be seen in a simulation. A surrogate of c(u,p,i) may be created by assuming a form for the surrogate that uses a parameterized function approximator such as a neural network, which is then trained on the set ũ to sufficiently approximate the behavior of C. In one embodiment, during training, random i are chosen from a bounded set.

### Handling FMUs, Model Exchange, and Co-Simulation

As described herein, the systems and methods for generating a training dataset simulate the sampled controllers from the configured space. In various embodiments, the source of this simulation may come from other platforms (i.e., wrapped us as functional mockup units (FMUs) from applicable simulation tools, or other representations such as S-functions from Simulink, or direct integration with existing simulators like direct calls to Dymola for Modelica code), or they may be written in the Julia computing language.

For example, in one embodiment where there are restrictions to accessing information about the simulator, the training may be extended to address such restrictions by choosing sufficiently short time intervals and approximating training against short time approximations. For this case, i(t) can be chosen from an approximating set, such as impulses or Fourier series.

In some cases, due to things such as the initialization process of the DAE, it may not be possible to set the initial condition of the co-simulation FMU. Thus, in an embodiment in which it is not possible to specify the initial conditions for such simulations, the controllers may instead be used to drive the system to a point that satisfies some given bounds of the system, the controllers are re-initialized, and then the data is collected.

### Automated Warnings for Untrained Regions

When the surrogate is used in the context of a simulation, values (u,p) that are seen can be checked against the training dataset u to determine if the values are sufficiently close to the training data using the same distance metric as described before. If the value is sufficiently far, a warning or error can be thrown to warn the user of potential errors introduced by extrapolating too far from the dataset.

### Existing Techniques for Representative Sampling of Dynamical Systems for Digital Twin Training

The resulting dataset of samples from the dynamic system should be: (1) explorative; (2) exploitative/dense; and (3) stable. Explorative refers to covering as much of the observable and input space of interest as possible. This enables capturing dynamics of the system in a larger space of observables and control inputs of interest. Exploitative/dense refers to densely and uniformly covering the explored observable and input space. This enables the data to capture a greater diversity of dynamics. Stable refers to sampling stable controllers that lead to stable trajectories. It is desirable to sample trajectories that are not diverging or noisy as these are usually the dynamics of interest when the surrogate is deployed. The systems and methods described herein seek to optimize one or more of these metrics (i.e., explorative, exploitative/dense, and stable) through various theoretical properties or heuristics.

To enable such a dense and stable exploration of space, there are two main categories of data sampling methods for dynamical systems: (1) one-shot methods, and (2) adaptive methods. With one-shot methods, all controllers used to generate data are pseudo randomly generated at the beginning of the data generation process.

With adaptive methods, new controllers are iteratively generated by using the generated data or the trained model performance as reference during each iteration and converge on the dataset of interest.

Traditional one-shot methods use different space-filling approaches to convert the entire control input space. These one-shot space-filling methods include: (1) (FA) PRBS; (2) Sinusoidal signals; or (3) Latin hypercube sampling.

(FA) PRBS. These are different variants of pseudorandom binary sequences with amplitude- and/or frequency-based modulation.

Sinusoidal Signals. These include combination of multiple sinusoids and/or frequency varying sinusoid signals, which are referred to as “chirps.”

Latin Hypercube Sampling. This is a statistical method for generating a near-random sample of parameter values from a multidimensional distribution.

All these methods are different traditional approaches to filling the control/parameter input space. These space-filling based approaches are inherently open-loop, as these controllers are not a function of observed variables, so they do not respond to the dynamics of the component system. This open-loop nature of the existing random controller techniques makes them limiting as they are unable to use the dynamics of the system to naturally explore the dynamics. Furthermore, their one-shot nature makes the techniques hit-or-miss and does not give opportunity to iteratively improve the data sampling procedure to converge to an ideal dataset.

Apart from one-shot methods, various kinds of adaptive methods are also known. “Adaptive” refers to the control input or the controller generation or the experiment design being done in an iterative fashion, as opposed to being done all at once. Initial sets of samples are generally simulated using some sort of space-filling-based technique as described above. Subsequent iterations of control input design are guided by previous data generated and/or performance of the trained surrogate. Since the subsequent iterations are informed by the existing data/models, the method is referred to as “adaptive.”

Adaptiveness is enabled by first identifying candidate control inputs using some candidature criteria, then by scoring the candidates using a scoring criteria, which is a function of the given candidate, existing data, and/or model. An issue with existing methods is that their scoring or candidature criteria are domain-specific.

This prevents these methods from being scalable to other domains without some non-trivial modifications or domain expertise.

Other known methods enable adaptiveness by designing a scoring criteria as a function of a trained surrogate. This often involves retraining a surrogate or family of surrogates with new data each iteration, which is very prohibitive to scale when the surrogate training complexity is significant.

Another known method enables adaptivity without training in the loop or having a domain-specific algorithm. However, the candidature and scoring criteria is prohibitively expensive computationally, which prevents use. Further, some of procedures used as part of scoring or candidature do not scale well with number of dimensions, and usage beyond 7 observable dimensions is discouraged. This limitation would disallow the usage of the technique in most applicative scenarios.

The inventors are unaware of any previously existing sampling techniques that work with closed-loop controllers. The known techniques of generating control signals are inherently open-loop. In the sampling process described herein below, the closed-loop nature of the sampled controllers is advantageous in enabling efficient exploration and exploitation of the dynamic system.

### The Inventive Sampling Process

As mentioned above, a non-linear dynamical system of interest often exists as a component in a larger interconnected network of models. Generating data for such systems can be computationally expensive, requiring the operation of the entire network to observe the individual component's input and its corresponding response. Consequently, a more efficient method is described herein that facilitates data generation by operating only the component model. In one embodiment, this process is underpinned by the use of closed-loop controllers, which facilitate a dense and stable exploration of the state space that would be seen during normal operation of the actual component model within its network. The systems and methods described herein enable the generation and training of surrogates that would otherwise be too computationally expensive to allow for accurate simulations. As described herein, the training of the surrogates enables simulations that have been traditionally impossible or impractical, thereby expanding the reach of types of systems that can be simulated. This provides numerous practical applications in that it allows for modeling of real-world physical systems that previously could not be performed, and it allows for accurate modeling while conserving computational resources.

In one embodiment, the method begins with a neural network whose initialization, architecture, and activation functions are parameterized in a way that allows for sampling stable controllers that can be run in a closed-loop fashion and maximize exploration. However, the method itself can take any machine learning, deep learning or statistical modeling form. The controller is then tuned in an open-loop manner, and due to its structure, preserves the tuning qualitatively when used in a closed-loop manner.

In one embodiment, the controller operates on normalized values of time or observables in an open- and closed-loop manner, respectively. In order to preserve scale and ensure the controller acts in a well-behaved manner, all inputs to the controller are normalized and scaled accordingly. The method of normalization can take any standard statistical procedure or non-statistical.

Following the selection of the controller's parameterized form and the normalization procedure for its inputs, the parameters are adjusted to identify an upper and a lower bound of activity. This process may be guided by the user's prior knowledge of the real-world use of the model, with an aim to approximate the average behavior of the system under typical operating conditions. To simplify this stage, in one embodiment, a graphical user interface (GUI) or human-machine interface may be provided, where the user manipulates sliders to alter the controller's response. By visualizing these changes, the user can intuitively determine what the range of activity of the controller and its upper- and lower-bound behaviors would look like, and thus what range of parameters the controllers should be sampled from. In other embodiments, the parameters may be determined programmatically or algorithmically, either with input from the user, or without input from the user.

Once the bounds have been established, the next stage involves sampling multiple controllers. This sampling process for the parameters is executed using a method such as a Quasi-Monte Carlo procedure or similar sampling technique. The sampled controllers are subsequently employed to simulate the system, thereby collecting data. This step leverages a wide range of controller behaviors, thereby increasing the probability of capturing the intricate nonlinear dynamics in the state space relevant to the real use of the model.

With the data collection complete, a surrogate model is trained. The surrogate model, serving as a computationally efficient approximation of the original model, is crucial for exploring and optimizing tasks. The performance of this surrogate model is subsequently evaluated, assessing its ability to effectively represent the original system given the data from the process mentioned above. Post-training, the surrogate model's performance is further scrutinized using a range of diagnostic tools. These include phase space and parallel coordinate plots, which visually illustrate the performance of the surrogate model in relation to the behavior of both the training and validation data.

In instances where the surrogate model's performance is inadequate for the validation and training of data, a resampling process is initiated. The process targets the regions of underperformance identified using a distance metric that measures the trajectory closest to the validation data. The system is reinitialized close to these areas, and the sampled controllers are rerun with these new initial conditions. In this manner, the systems and methods described herein encompass the closed feedback loop to facilitate computationally efficient, dense sampling from an unknown dynamical system over a large phase space, while efficiently allowing the training to be handled externally from the loop. The quality of the trained surrogate itself can guide the further sampling of newer controllers using the described method and complete an active learning loop.

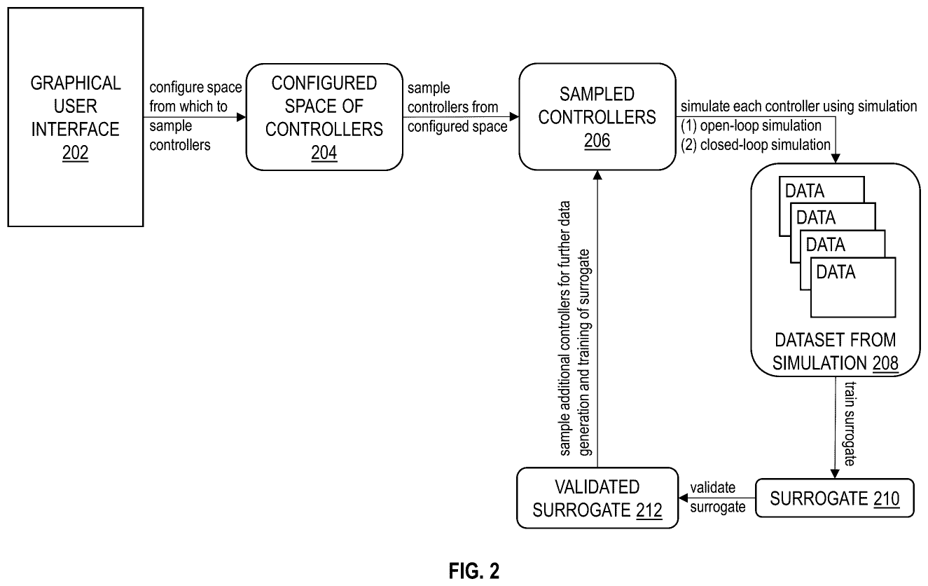

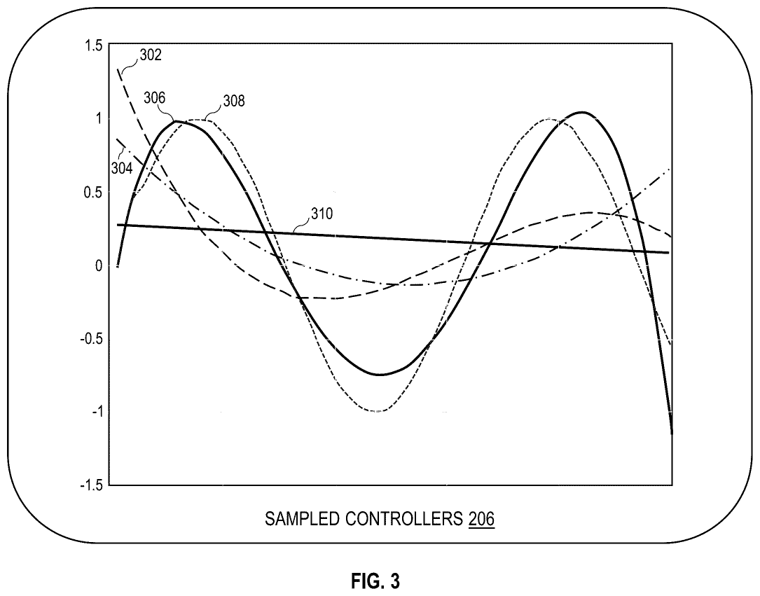

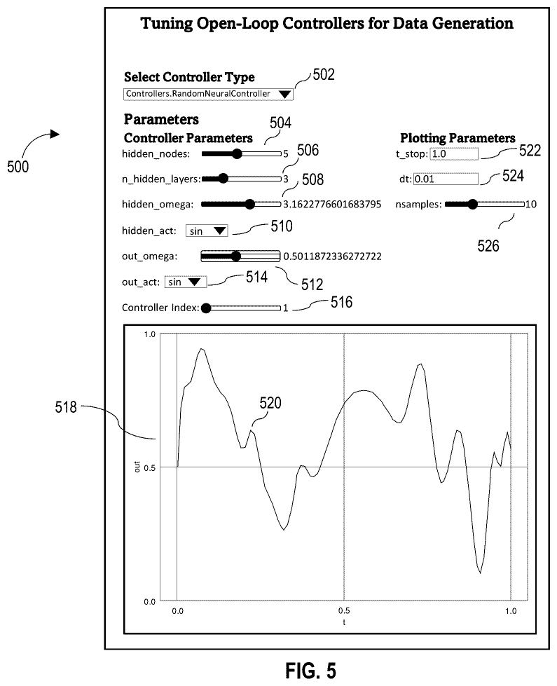

FIG. 2 depicts a block diagram showing data flow for generating a training dataset used to train and validate a surrogate in accordance with an embodiment disclosed herein. Referring to FIG. 2, the user configures a space from which to sample controllers. The space may be configured graphically through a graphical user interface 202, as shown in FIG. 2. The space may be configured through other human-machine interfaces (HMI) as well. The user may adjust one or more controller parameters of the controller in real-time to arrive at a particular controller representation (discussed in the context of FIG. 5). These adjusted controller parameters provide a configured space of controllers 204. A plurality of controllers are sampled from the configured space to generate sampled controllers 206 (example shown in FIG. 3). One or more of the controllers may be randomized. The sampled controllers 206 occupy a space that is similar to the controller that the user configured, for example, using the GUI 202. One or more of the sampled controllers 206 are simulated using a simulation. The simulation may be an open-loop simulation, in which the results from the simulation are not used as part of the input to the simulation. The simulation may alternatively be a closed-loop simulation, in which the system waits for the simulation to respond and adjusts the simulation accordingly (i.e., results from the simulation are used as part of the input to the simulation). In either case, the simulation of the plurality of controllers generates a dataset from the simulation 208. The generated dataset 208 is used to train the surrogate model 210. The surrogate model 210 is then validated using hold-out data, which is data that was not included in the training dataset. This allows for the validation to confirm that the trained surrogate 210 operates as expected on data on which the surrogate was not trained. After the surrogate has been validated such that it is a validated surrogate 212, additional controllers are sampled for further data generation and training of the surrogate. The additional controllers may be randomized controllers. This allows for additional training of the surrogate 210, 212 to address controllers that were not captured in the initial training set, for example, if it is identified during the validation process that the data generated is not enough to reliably deploy the surrogate and use it for its intended purpose. The process of training, validating, and sampling additional controllers may be repeated as necessary to optimize the surrogate.

FIG. 3 depicts examples of sampled controllers 206 shown in FIG. 2. Referring to FIG. 3, each of lines 302, 304, 306, 308, and 310 represent a sampled controller as used in FIG. 2.

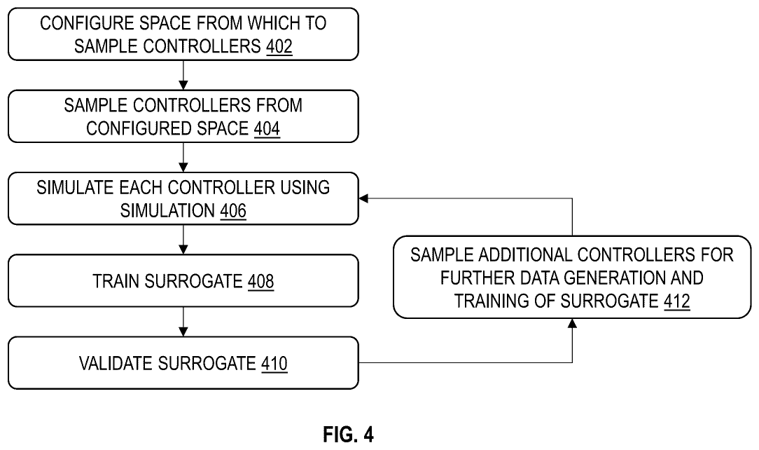

FIG. 4 depicts an exemplary process flow for training a surrogate model representing a physical system without knowledge of a controller for the physical system. Referring to FIG. 4, a space from which to sample controllers is configured at step 402. Controllers from the configured space are sampled at step 404. One or more of the sampled controllers may be randomized within the configured space. In various embodiments, the set of sampled controllers may be one or more of proportional-integral-derivative controllers, dynamical system controllers, feed-forward architecture controllers, and/or surrogate controllers. Each of the sampled controllers is simulated using a simulation at step 406. In one embodiment, the simulations are performed using open-loop simulation. In another embodiment, the simulations are performed using closed-loop simulation. The process of simulating each of the sampled controllers generates a dataset from the simulations. The generated data set is used to train a surrogate at step 408. The trained surrogate is validated at step 410. In an embodiment, the validation is performed using hold-out data, as explained previously. Finally, at step 412, additional controllers are sampled for further data generation and training of the surrogate. The process of sampling additional controllers for further data generation and training of the surrogate may be repeated one or more times to cover the configured space, to address controllers that were not previously sampled, and/or to optimize the trained surrogate.

FIG. 5 depicts an exemplary GUI to allow the user to tune or define one or more controllers. Referring to FIG. 5, GUI 500 represents an exemplary embodiment of graphical user interface 202 shown in FIG. 202. The user may use GUI 500 to adjust one or more parameters, such as hidden nodes, hidden layers, hidden omega, for example, using one or more slider controls 504, 506, 508, 512, and/or 512, or other types of controls 510 and 514. As the one or more slider controls are adjusted, the real-time graphical display 518 of the controller 520 is updated to reflect the configured controller. This allows the user to see in real-time the effect of the adjustments made to the parameters. The GUI 500 allows the user to select controller type 502. The GUI 500 further allows the user to configure plotting parameters for the controllers, as shown in 522, 524, and 526. Separately, as explained above, in an embodiment, the GUI 500 may further allow the user to define an interval of controllers by specifying a lower-bound controller and an upper-bound controller, and the systems and methods described herein interpolate controllers between the two bounding controllers.

One embodiment or step-by-step use case of the systems and methods described herein is as follows. Assume a user wants to generate a component surrogate for a battery model to be used in an electric vehicle.

The user begins by running the tuning application. In one embodiment, the tuning application may be started using the following Julia code:
datagen_tuning_app ( )

In one embodiment, a GUI is used to allow the user to tune the controller as discussed, for example, as shown in FIG. 5. The GUI may include a plot or graph that displays a real-time visualization of the controller as the user adjusts the controller parameters. One benefit of the GUI including a real-time visualization (e.g., as shown in FIG. 5) is that even if the user has no knowledge of what some or all of the parameters represent, the user simply adjusts the slider and chooses the activity of the controller that best represents the controller, allowing the user to build intuition as they use the application. Separately, the GUI may allow the user to define a lower-bound controller and an upper-bound controller, which define the upper bound and lower bound of the expected activity from the controller. For example, the user may define a weak controller as the lower-bound controller and a strong (i.e., chaotic) controller as the upper-bound controller.

Once the user has tuned the controller (or interval of controllers bounded the upper-bound controller and the lower-bound controller) by adjusting the parameters to the user's desired values, those parameters (which may be displayed on the GUI) are used to sample one or more controllers. The samples from the one or more controllers are then used to run the simulations. In an embodiment, the simulations may be run using the following lines of Julia code:

```
random_ctrl = RandomNeuralController(N_CTRL_INPUTS;
  n_hidden = params.hidden_nodes,
  n_hidden_layers = params.n_hidden_layers,
  hidden_activation = x −>
params.hidden_act(params.hidden_omega * x),
  activation = x −> params.out_act(params.out_omega * x))
ctrl_space = CtrlSpace(CTRL_LB, CTRL_UB, simple_closed_loop_f,
nsamples, random_ctrl)
sim_config = SimulatorConfig(ctrl_space)
samples = sim_config(prob)
```

The above code starts off by instantiating a controller generation algorithm with the parameters that were discovered using the tuning app (as shown in FIG. 5). The control space is then specified by describing the controller upper and lower bound, open/closed-loop nature of the controller, and the number of samples. This is then used to specify the configuration of the simulation and to use that to sample data for the battery problem.

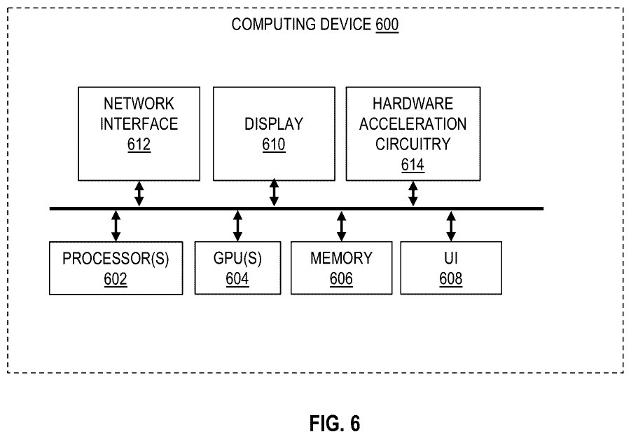

FIG. 6 depicts a block diagram illustrating one embodiment of a computing device that implements the methods and systems described herein. Referring to FIG. 6, the computing device 600 may include at least one processor 602, at least one graphical processing unit (“GPU”) 604, a memory 606, a user interface (“UI”) 608, a display 610, a network interface 612, and hardware acceleration circuitry 614. The memory 606 may be partially integrated with the processor(s) 602, the GPU(s) 604, and/or the hardware acceleration circuitry 614. The hardware acceleration circuitry 614 may be specialized circuitry or hardware specific circuitry, such as an ASIC or FPGA. The UI 608 may include a keyboard and a mouse. The display 610 and the UI 608 may provide any of the GUIs in the embodiments of this disclosure.

The methods described herein may be implemented on one or more computing devices, such as the computing device described in the context of FIG. 6. For example, the process flow depicted in FIG. 4 and FIG. 5, and described in the context of FIG. 4, and FIG. 5 may be implemented on a computing device described in the context of FIG. 6.

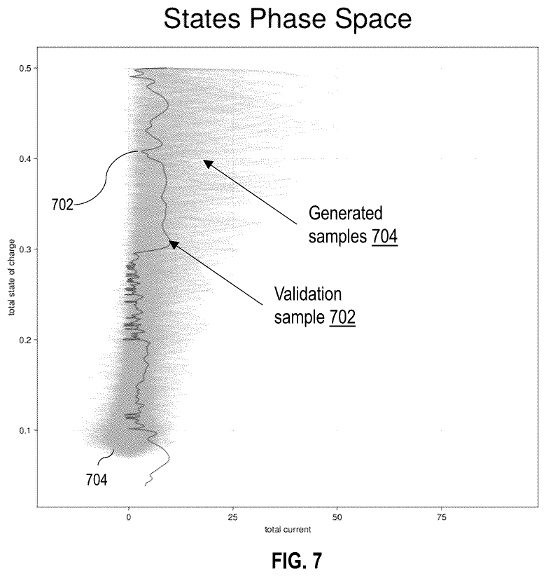

FIG. 7 depicts a graph showing the states phase space of a training dataset generated by the systems and methods described herein. The phase space of the generated samples is shown in FIG. 7. The larger portion 704 (depicted in the lighter shade and shown as 704 and “generated samples” in FIG. 7) represents the samples generated by the controllers instantiated using the method, and the line 702 overlaid on the larger portion 704 represents a real-life validation sample. As can be seen in FIG. 7, the controllers generated using this method have generated data samples in the region of state space that covers the region that the validation or real-life data exists. This shows that the generated samples 704 used to train the surrogate are sufficient to simulate the real-world system.

Upon training a surrogate using the data samples obtained using the above procedure, the model is validated against real-world data and a sample from training data whose plots are shown below.

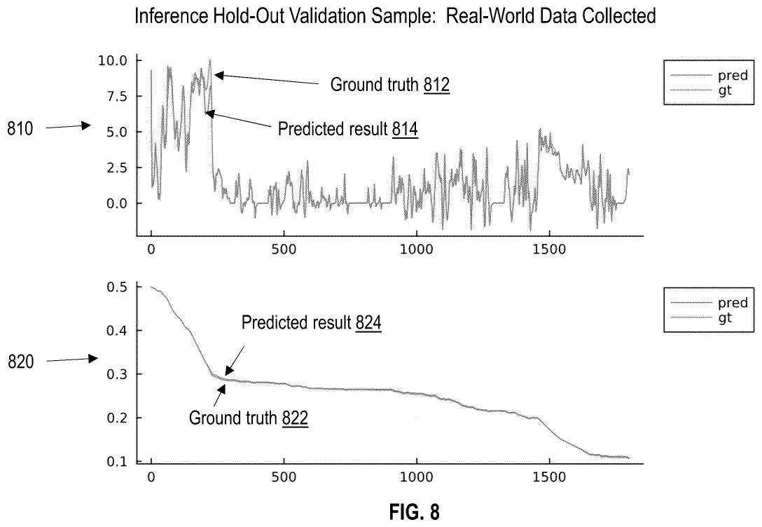

FIG. 8 depicts results showing an inference hold-out validation sample. Chart 810 of FIG. 8 shows two lines, one line 814 that represents the predicted values, and one line 812 that represents the ground truth from real-world data collected. As can be seen from chart 810 shown in FIG. 8, the two lines 814 (predicted) and 812 (ground truth) track each other very closely, which indicates that the prediction matches the ground truth quite accurately. Similarly, chart 820 of FIG. 8 likewise shows the predicted values 824 compared to the ground truth values 822. As with chart 810, chart 820 likewise shows that the two lines 824 (predicted) and 822 (ground truth) are so close to overlapping that they nearly appear as a single line.

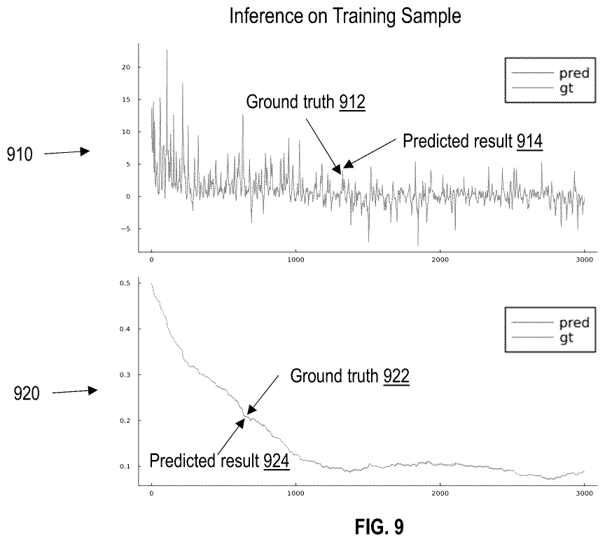

FIG. 9 depicts results showing the inference on the training sample. Charts 910 and 920 of FIG. 9 show the data that the surrogate was trained on. As is the case with FIG. 8, it can be seen in FIG. 9 that the predictions and the ground truth of the training data match very closely, such that the lines overlap as to nearly appear as a single line. In particular, predicted results 914 nearly match ground truth 912 in chart 910, and predicted results 924 nearly match ground truth 922 in chart 920.

Thus, as can be seen from both FIG. 8 and FIG. 9, even observables with involved dynamics can be closely predicted. Using surrogates that have been trained and validated using the systems and methods described herein. As explained above, the training of these surrogates significantly reduces the computational resources required to generate these surrogates, which leads to increased computational efficiency, as well as allowing for large-scale simulations that would previously impossible or very impractical because of the computational complexity required. The systems and methods described herein may be used as standalone compilers or modeling systems in scientific computing, and they may further be used to generate trained surrogates as stand-alone objects or systems that can be plugged into other compilers or scientific computing systems.

Aspects of the present disclosure may take the form of an entirely hardware embodiment, an entirely software embodiment as a programmatic method (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including the Julia scientific computing language or an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These non-transitory computer program instructions may also be stored in a non-transitory computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. The embodiments were chosen and described in order to best explain the principles of the present disclosure and the practical application, and to enable others of ordinary skill in the art to understand the present disclosure for various embodiments with various modifications as are suited to the particular use contemplated.

These and other changes can be made to the disclosure in light of the Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

The subject matter described herein may include the use of machine learning performed by at least one processor of a computing device and stored as non-transitory computer executable instructions (software or source code) embodied on a non-transitory computer-readable medium (memory). Machine learning (ML) is the use of computer algorithms that can improve automatically through experience and by the use of data. Machine learning algorithms build a model based on sample data, known as training data, to make predictions or decisions without being explicitly programmed to do so. Machine learning algorithms are used where it is unfeasible to develop conventional algorithms to perform the needed tasks.

In certain embodiments, instead of or in addition to performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationship between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

The systems and methods may support different hardware platforms/architectures, may add implementations for new network layers and new hardware platforms/architectures, and may be optimized in terms of processing, memory and/or other hardware resources for a specific hardware platform/architecture being targeted. Examples of platforms are different GPUs (e.g., Nvidia GPUs, ARM Mali GPUs, AMD GPUs, etc.), different forms of CPUs (e.g., Intel Xeon, ARM, TI, etc.), and programmable logic devices, such as Field Programmable Gate Arrays (FPGAs).

Exemplary target platforms include host computers having one or more single core and/or multicore CPUs and one or more Parallel Processing Units (PPUs), such as Graphics Processing Units (GPUs), and embedded systems including single and/or multicore CPUs, microprocessors, Digital Signal Processors (DSPs), and/or Field Programmable Gate Arrays (FPGAs).

The subject matter described herein may be executed using a distributed computing environment. The environment may include client and server devices, interconnected by one or more networks. The distributed computing environment also may include target platforms. The target platform may include a multicore processor. Target platforms may include a host (Central Processing Unit) and a device (Graphics Processing Unit). The servers may include applications or processes accessible by the clients. The devices of the environment may interconnect via wired connections, wireless connections, or a combination of wired and wireless connections.

The servers may include one or more devices capable of receiving, generating, storing, processing, executing, and/or providing information. For example, servers may include a computing device, such as a server, a desktop computer, a laptop computer, a tablet computer, a handheld computer, or a similar device.

The clients may be capable of receiving, generating, storing, processing, executing, and/or providing information. Information may include any type of machine-readable information having substantially any format that may be adapted for use, e.g., in one or more networks and/or with one or more devices. The information may include digital information and/or analog information. The information may further be packetized and/or non-packetized. In an embodiment, the clients may download data and/or code from the servers via the network. In some implementations, the clients may be desktop computers, workstations, laptop computers, tablet computers, handheld computers, mobile phones (e.g., smart phones, radiotelephones, etc.), electronic readers, or similar devices. In some implementations, the clients may receive information from and/or transmit information to the servers.

The subject matter described herein and/or one or more of its parts or components may comprise registers and combinational logic configured and arranged to produce sequential logic circuits. In some embodiments, the subject matter described herein may be implemented through one or more software modules or libraries containing program instructions pertaining to the methods described herein, that may be stored in memory and/or on computer readable media, and may be executed by one or more processors. Other computer readable media may also be used to store and execute these program instructions. In alternative embodiments, various combinations of software and hardware, including firmware, may be utilized to implement the present disclosure.

A person having ordinary skill in the art will recognize that the principles described herein may be applied to other physical systems not explicitly described herein, as the model described herein here provides a framework that is not specific to any particular physical system but rather can be used to train surrogates that represent components of any physical system.

The descriptions of the various embodiments of the technology disclosed herein have been presented for purposes of illustration, but these descriptions are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for training a surrogate model representing a physical system without knowledge of a controller for the physical system, the system comprising:
one or more hardware processors configured for:
configuring a control space from which to sample one or more controllers to generate a configured control space of controllers, wherein the control space is configured based on input received from a user;
sampling a first plurality of controllers from the configured control space to generate a set of sampled controllers;
simulating one or more controllers of the set of sampled controllers using a simulation to generate a dataset from the simulation;
training a surrogate using the dataset generated from the simulation;
validating the trained surrogate using data from the physical system, wherein the data from the physical system used to validate the trained surrogate is not part of the dataset from the simulation used to train the surrogate; and
sampling a second plurality of controllers based on the validation of the trained surrogate to further train the surrogate.

2. The system of claim 1, wherein the input received from the user is provided through a graphical user interface (GUI) that allows the user to configure one or more controller parameters.

3. The system of claim 2, wherein the GUI includes a graph that represents a controller, and wherein the one or more controller parameters are configured visually using the GUI and the graph.

4. The system of claim 1, wherein the input received from the user includes a lower-bound controller and an upper-bound controller.

5. The system of claim 1, wherein the control space is configured programmatically based on the input received from the user.

6. The system of claim 1, wherein the control space is configured algorithmically based on the input received from the user.

7. The system of claim 1, wherein one or more controllers of the first plurality of controllers are randomized controllers.

8. The system of claim 1, wherein the set of sampled controllers captures locally diverse dynamics of the physical system.

9. The system of claim 1, wherein the set of sampled controllers includes proportional-integral-derivative controllers, dynamical system controllers, feed-forward architecture controllers, or surrogate controllers.

10. The system of claim 1, wherein the simulation is an open-loop simulation.

11. The system of claim 1, wherein the simulation is a closed-loop simulation.

12. A programmatic method for training a surrogate model representing a physical system without knowledge of a controller for the physical system, the programmatic method comprising:
configuring a control space from which to sample one or more controllers to generate a configured control space of controllers, wherein the control space is configured based on input received from a user;
sampling a first plurality of controllers from the configured control space to generate a set of sampled controllers;
simulating one or more controllers of the set of sampled controllers using a simulation to generate a dataset from the simulation;
training a surrogate using the dataset from the simulation;
validating the trained surrogate using data from the physical system, wherein the data from the physical system used to validate the trained surrogate is not part of the dataset from the simulation used to train the surrogate; and
sampling a second plurality of controllers based on the validation of the trained surrogate to further train the surrogate.

13. The programmatic method of claim 12, wherein the input received from the user is provided through a graphical user interface (GUI) that allows the user to configure one or more controller parameters.

14. The programmatic method of claim 13, wherein the GUI includes a graph representing a controller, and wherein the one or more controller parameters are configured visually using the GUI and the graph.

15. The programmatic method of claim 12, wherein the input received from the user includes a lower-bound controller and an upper-bound controller.

16. The programmatic method of claim 12, wherein the control space is configured programmatically based on the input received from the user.

17. The programmatic method of claim 12, wherein the control space is configured algorithmically based on the input received from the user.

18. The programmatic method of claim 12, wherein one or more controllers of the first plurality of controllers are randomized controllers.

19. The programmatic method of claim 12, wherein the set of sampled controllers captures locally diverse dynamics of the physical system.

20. The programmatic method of claim 12, wherein the set of sampled controllers includes proportional-integral-derivative controllers, dynamical system controllers, feed-forward architecture controllers, or surrogate controllers.

21. The programmatic method of claim 12, wherein the simulation is an open-loop simulation.

22. The programmatic method of claim 12, wherein the simulation is a closed-loop simulation.
